(19) United States
(12) Patent Application Publication
(10) Pub. No.: US 2019/0095447 A1
(43) Pub. Date: Mar. 28, 2019

(54) METHOD, APPARATUS, DEVICE AND STORAGE MEDIUM FOR ESTABLISHING ERROR CORRECTION MODEL BASED ON ERROR CORRECTION PLATFORM

(71) Applicant: BEIJING BAIDU NETCOM SCIENCE AND TECHNOLOGY CO., LTD., Beijing (CN)

(72) Inventors: Qiugen XIAO, Beijing (CN); Jinbo ZHAN, Beijing (CN); Kunsheng ZHOU, Beijing (CN); Liqun ZHENG, Beijing (CN); Zhihong FU, Beijing (CN); Jingzhou HE, Beijing (CN)

(21) Appl. No.: 16/054,966

(22) Filed: Aug. 3, 2018

(30) Foreign Application Priority Data
Sep. 27, 2017 (CN) 201710890348.6

(51) Int. Cl. G06F 17/30; G06N 99/00

(52) U.S. Cl. CPC G06F 17/3064; G06F 17/2735; G06F 17/30867; G06N 99/005

(57) ABSTRACT

Embodiments of the disclosure disclose a method, apparatus, device, and storage medium for establishing an error correction model based on an error correction platform. The method comprises: determining a target error correction level based on an error correction need of a user; and selecting at least one error correction module from each of at least two error correcting portions of the error correction platform based on the target error correction level, and combining the selected error correction module to form an error correction model.

### CROSS-REFERENCE TO RELATED APPLICATIONS

This application claims the priority of Chinese Application No. 201710890348.6, filed on Sep. 27, 2017, titled “Method, Apparatus, Device and Medium for Establishing Error Correction Model Based on Error Correction Platform,” the entire disclosure of which is incorporated herein by reference.

### TECHNICAL FIELD

Embodiments of the disclosure relate to the error correction model processing technique based on the computer data processing technology, and in particular to a method, apparatus, device and storage medium for establishing an error correction model based on an error correction platform.

### BACKGROUND

At present, the artificial intelligence technology has been widely used. Artificial intelligence (AI) is a new technological science that studies and develops theories, methods, techniques and application systems for simulating, extending and expanding human intelligence. Artificial intelligence is a branch of computer science that attempts to understand the essence of intelligence and produces new intelligent machinery capable of responding in a way similar to human intelligence. Studies in the field include robots, speech recognition, image recognition, natural language processing, expert systems, and the like.

For example, during query retrieval, a user often inputs, due to negligence or other reasons, incorrect search terms, such as inputting “Qinghua University” or “Qinhua University” for Tsinghua University.” For another example, “Radio Summer” may be inputted for “Radio Building.” Therefore, a search engine is required to be able to identify user-entered incorrect search terms, and correct the incorrect portion into correct search terms originally intended by the users.

Existing technologies usually independently develop corresponding error correction models for websites or other retrievable intelligent devices to correct user-entered texts. For example, the existing technology will independently develop an error correction model vis-à-vis the product retrieval needs of a website at the initial stage. However, the defects of the technologies include: a high coupling degree between an error correction model and a website, and failure to adapt to each development stage of the website. With the continuous development of the website, it is necessary to redevelop the error correction solution to obtain an error correction model that is more adaptive to the specific field or the current development stage corresponding to the website. Therefore, the error correction model provided by the existing technologies has an insufficient reusability, and fails to adapt to website growth and user data accumulation.

### SUMMARY

Embodiments of the disclosure provide a method, apparatus, device, and storage medium for establishing an error correction model based on an error correction platform, and achieve the error correction platform that may be adaptive to different development stages of a website or an intelligent device, and has a high error correction efficiency and a sufficient reusability.

In a first aspect, an embodiment of the disclosure provides a method for establishing an error correction model based on an error correction platform, including:

determining a target error correction level based on an error correction need of a user; and

selecting at least one error correction module from each of at least two error correcting portions of the error correction platform based on the target error correction level, and combining the selected error correction modules to form an error correction model.

In a second aspect, an embodiment of the disclosure further provides an apparatus for establishing an error correction model based on an error correction platform, the apparatus including:

an error correction level determining module, configured to determine a target error correction level based on an error correction need of a user; and

an error correction model formation module, for selecting at least one error correction module from each of at least two error correcting portions of the error correction platform based on the target error correction level, and combining the selected error correction modules to form an error correction model.

In a third aspect, an embodiment of the disclosure further provides a device, the device including:

one or more processors; and

a memory, for storing one or more programs,

where when executed by the one or more processors, the one or more programs causes the one or more processors to implement the method for establishing an error correction model based on an error correction platform according to any embodiment of the disclosure.

In a fourth aspect, an embodiment of the disclosure provides a storage medium comprising a computer executable instruction, where when executed by a computer processor the computer executable instruction is used for executing the method for establishing an error correction model based on an error correction platform according to any embodiment of the disclosure.

Embodiments of the disclosure provide a method, device, and storage medium for establishing an error correction model based on an error correction platform, and have solved the problems of existing technologies, such as a high coupling degree between the error correction model and the website, and failure to adapt to each development stage of the website, by determining the target error correction level based on the error correction need of the user, selecting at least one error correction module from each of at least two error correcting portions of the error correction platform based on the target error correction level and combining the selected error correction modules to form the error correction model corresponding to the target error correction level. With above technical solution, as the website continuously develops and effective resources continuously increase, redeveloping a reusable platform-based error correction solution is not needed, and quickly and easily customizing the error correction model based on actual error correction need of the user, a specific application scenario and a current development stage of the website are achieved.

### BRIEF DESCRIPTION OF THE DRAWINGS

FIG. 1 is a process diagram of a method for establishing an error correction model based on an error correction platform according to a first embodiment of the disclosure;

FIG. 2 is a process diagram of a method for establishing an error correction model based on an error correction platform according to a second embodiment of the disclosure;

FIG. 3 is a process diagram of a method for establishing an error correction model based on an error correction platform according to a third embodiment of the disclosure;

FIG. 4 is a block diagram of a structure of an apparatus for establishing an error correction model based on an error correction platform according to a fourth embodiment of the disclosure; and

FIG. 5 is a schematic diagram of a structure of a device according to a fifth embodiment of the disclosure.

### DETAILED DESCRIPTION OF EMBODIMENTS

The disclosure is further described in detail below in conjunction with the accompanying drawings and embodiments. It may be appreciated that the embodiments described here are only used for illustrating the disclosure, rather than limiting the disclosure. Furthermore, it should also be noted that only the parts associated with the disclosure, rather than all structure, are shown in the accompanying drawings to facilitate description.

### First Embodiment

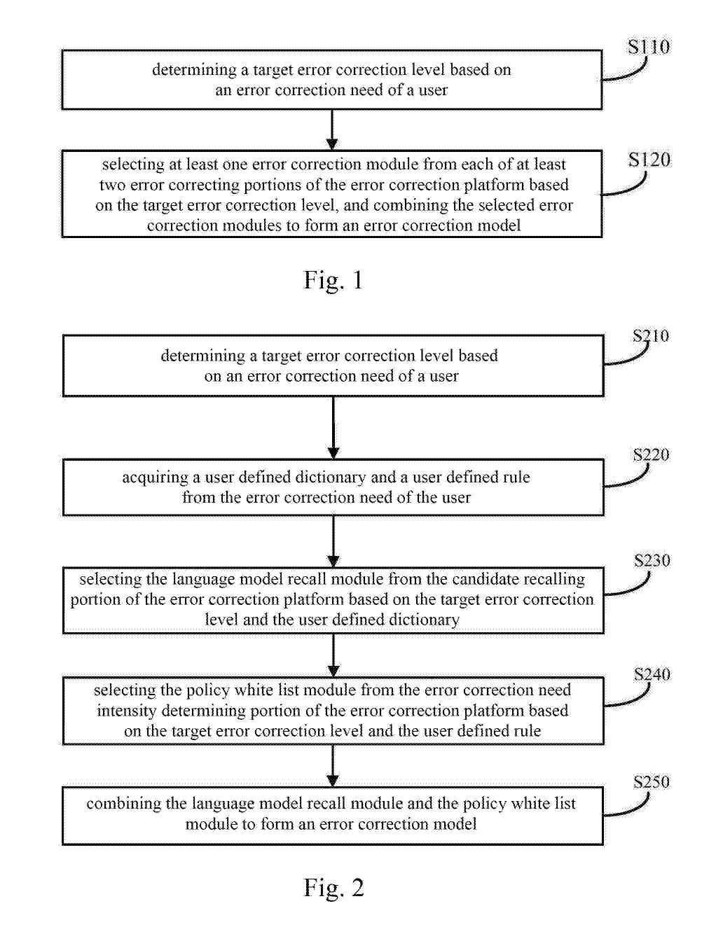

FIG. 1 is a process diagram of a method for establishing an error correction model based on an error correction platform based on an error correction platform according to a first embodiment of the disclosure. The method according to the embodiment may be executed by an apparatus for establishing an error correction model based on an error correction platform, which may be implemented by hardware and/or software and may be generally integrated into a server establishing the error correction model. The method according to the embodiment specifically includes steps 110-120.

Step 110 includes: determining a target error correction level based on an error correction need of a user.

As an example, in the embodiment, the user is preferably an application side of different websites. Here, the error correction need of the user is associated with an application scenario corresponding to the website and a development stage of the website. Because the website may accumulate different data at different development stages, the higher the level of the development stage of the website is, the higher the corresponding target error correction level is, and the more complex the error correction content is. Therefore, the target error correction level determines the error correction depth. For example, for product retrieval needs of the website at the initial stage, because the website does not store any user data, the target error correction level is low, and generally a universal error correction model can meet user needs. When the website develops to a mature stage, the website collects behavior logs and annotated corpora of different users. In this case, the target error correction level is high, and only an error correction model matching the mature stage of the website can meet the error correction need of the user.

As an example, the error correction need provided by the user may contain multiple resources associated with the application side of the website, such as a customized scenario corresponding to the error correction model or historical data associated with the user. The target error correction level of the user may also be determined based on the multiple resources provided by the application side. For example, if the application side only provides some corpora associated with the application scenario, e.g., a bus corpus associated with a public transport system or a hospital retrieval corpus associated with a medical system, then the target error correction level is a primary level; if the application side provides some customized dictionaries and rules of the website, for example, for a catering website, specific dish names of major styles of cooking are provided, or for an entertainment website, a customized entertainment project name and other resources are provided, then the target error correction level enters an intermediate level, and the error correction model needs to satisfy the error correction need under the customized condition; and for a vertical medical retrieval, if the application side of the website further provides specific user behavior data associated with retrieval behaviors of the user, then the target error correction level is a high level, and an error correction model with a higher level of an error correction capability is required to adapt to the error correction need of the application scenario.

Step 120 includes: selecting at least one error correction module from each of at least two error correcting portions of the error correction platform based on the target error correction level, and combining the selected error correction modules to form the error correction model.

As an example, the error correction platform according to the embodiment may be applied to a search engine of the website at different development stages. The error correction platform is integrated with at least two error correcting portions, and each of the error correcting portions includes at least one error correction module, used as the basis for establishing the error correction model. Here, selection of the error correcting portion and the error correction module thereof is determined based on the target error correction level. At different development stages, different error correcting portions and error correction modules thereof are selected.

In the embodiment, the selecting at least one error correction module from each of at least two error correcting portions of the error correction platform based on the target error correction level may specifically include: determining a customized scenario from the error correction need of the user, and selecting at least one error correction module from each of the at least two error correcting portions of the error correction platform based on the target error correction level and the customized scenario.

Those skilled in the art may understand that generally there is a universal error correction model in the error correction platform. Here, the universal error correction model contains some default error correction modules, such as a normalization module, and a language model recall module. The universal error correction model has accurate error correction results of daily expressions, common phrases, and the like, but is difficult to accurately correct errors of specific phrases in specific fields and specific vocabularies in some specific scenarios. Therefore, according to the embodiment, by selecting at least one error correction module from each of at least two error correcting portions of the error correction platform, multiple error correction policies are complementary to each other, the error correction model is formed by combination, and then the universal error correction model may be corrected, so that the corrected error correction model may correctly correct errors in a text based on the customized scenario in the error correction need of the user.

Furthermore, according to the embodiment, after the selecting at least one error correction module from each of at least two error correcting portions of the error correction platform based on a target error correction level, user historical data may be acquired from the error correction need of the user, and the error correction module may be trained using the user historical data.

As an example, the user historical data may include information, such as a user behavior log and an annotated corpus. Here, the user historical data may be directly provided in a text form, or downloaded from a link address provided by the user. When the error correction need of the user contains the user historical data, it indicates that the application website of the error correction platform has developed to the mature stage. In this case, a deeply customized error correction model adaptive to the mature stage of the website may be obtained by training the error correction module using the user historical data.

The embodiment of the disclosure provides a method for establishing an error correction model based on an error correction platform, and has solved the problems of existing technologies, such as a high coupling degree between the error correction model and the website, and failure to adapt to each development stage of the website, by determining the target error correction level based on the error correction need of the user, and selecting at least one error correction module from each of at least two error correcting portions of the error correction platform based on the target error correction level and combining the selected error correction modules to form the error correction model. With above technical solution, as the website continuously develops and effective resources continuously increase, redeveloping a reusable platform-based error correction solution matching the current application scenario and the development stage is not needed, and quickly and easily customizing an error correction model corresponding to a specific application scenario and a current development stage of a website based on actual error correction need of the user are achieved.

### Second Embodiment

FIG. 2 is a process diagram of a method for establishing an error correction model based on an error correction platform according to a second embodiment of the disclosure. This embodiment is optimized on the basis of the above embodiment. In the embodiment, at least two error correcting portions are a normalizing portion, an error correction need intensity determining portion, a candidate recalling portion and an error correction candidate rating and generating portion. Accordingly, the selecting at least one error correction module from each of at least two error correcting portions of the error correction platform specifically includes: selecting a normalization module from the normalizing portion of the error correction platform; selecting a policy white list module, a segment compactness entropy module and a user behavior decision module from the error correction need intensity determining portion; selecting a language model recall module, a double deletion method recall module and an aligned segment recall module from the candidate recalling portion; and selecting a basic static error correction module and a supervised model error correction module from the error correction candidate rating and generating portion. Accordingly, the embodiment embodies the determining a customized scenario from the error correction need of the user, and selecting at least one error correction module from each of the at least two error correcting portions of the error correction platform based on the target error correction level and the customized scenario. As shown in FIG. 2, the method according to the embodiment specifically includes steps 210 to 250.

Step 210 includes: determining a target error correction level based on an error correction need of a user.

Step 220 includes: acquiring a user defined dictionary and a user defined rule from the error correction need of the user.

As an example, different application scenarios have customized dictionaries and customized rules corresponding thereto. The customized dictionaries and the customized rules may be provided by an application side of the error correction platform in a text form. Of course, researchers may also summarize customized dictionaries and customized rules corresponding to the error correction need of the user from correct or incorrect cases. Here, the customized dictionaries may be information of proper nouns associated with the application scenario. For example, for a bus error correction system, the user may provide information of all bus names and bus stops in a country as the customized dictionary.

As an example, the customized rule is a rule about whether to perform an error correction on a special situation, which is customized by the user based on a specific application scenario. For example, for an error correction of a text, words within quotation marks of the text generally have special meanings, and the customized rule is that the error correction is not performed on text information within the quotation marks.

Step 230 includes: selecting the language model recall module from the candidate recalling portion of the error correction platform based on the target error correction level and the user defined dictionary.

As an example, in a voice recognition system, if the voice recognition system identifies a user-entered keyword A as another incorrect keyword B, a proper noun dictionary (or a customized dictionary) corresponding to the keyword A may be recalled through a homonym of the keyword B based on the language model recall module, thereby recalling the user-entered keyword A.

Step 240 includes: selecting the policy white list module from the error correction need intensity determining portion of the error correction platform based on the target error correction level and the user defined rule.

Here, the policy white list module is mainly for some queries for which the error correction is needless, for example, proper nouns such as encyclopedia entries, and user-defined dictionaries. As an example, when the error correction platform corrects errors of user-entered text information, if above queries for which the error correction is needless, for example proper nouns such as encyclopedia entries, and user-defined dictionaries, are identified in a text, then the queries for which the error correction is needless, proper nouns and user-defined dictionaries are filtered, and are not subject to the error correction.

Step 250 includes: combining the language model recall module and the policy white list module to form an error correction model.

It should be noted that there is not a sequential order between the step 240 and the step 230, and the error correction model formed by combining the language model recall module and the policy white list module selected based on the target error correction level, the user-defined dictionary and the user-defined rule is more adaptive to the customized scenario, and has more accurate error correction result.

The second embodiment is embodied on the basis of the above embodiment, and the error correction model of the customized scenario corresponding to the error correction need of the user may be easily and quickly customized by embodying the error correcting portion and the error correction module without redeveloping a new error correction policy. Furthermore, by acquiring the user defined dictionary and the user defined rule from the error correction need of the user, the language model recall module and the policy white list module may be selected, and combined to form the error correction model corresponding to the specific application scenario of the user, thereby improving the error correction effect.

### Third Embodiment

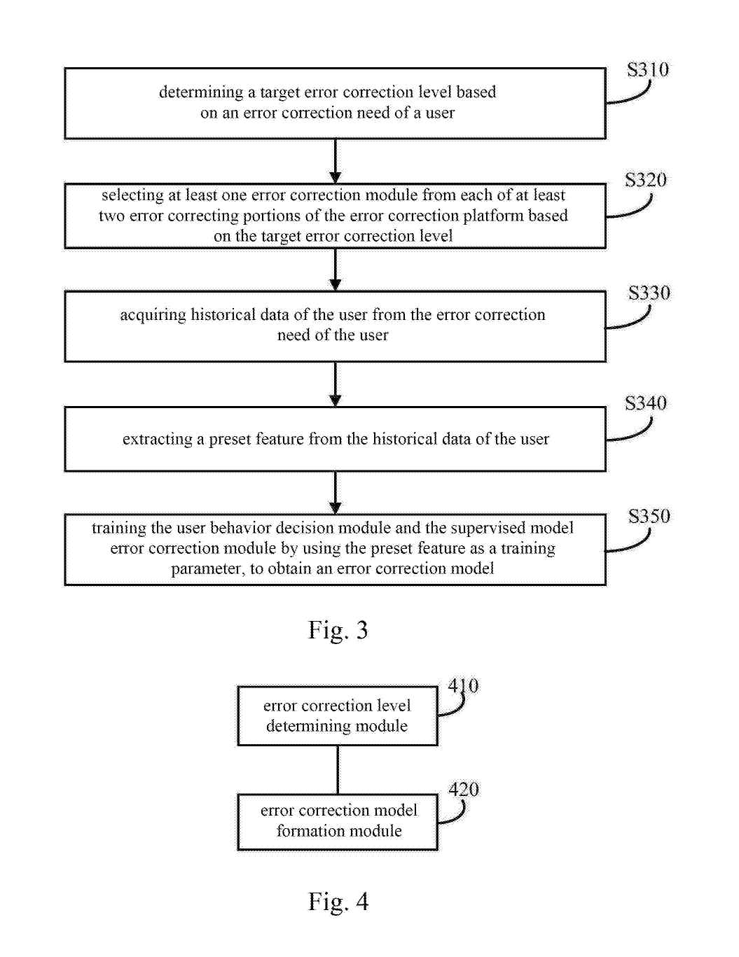

FIG. 3 is a process diagram of a method for establishing an error correction model based on an error correction platform according to a third embodiment of the disclosure. This embodiment is optimized on the basis of the above embodiments. According to this embodiment, the acquiring historical data of the user from the error correction need of the user, and training the error correction module using the historical data of the user specifically includes: acquiring historical data of the user from the error correction need of the user, extracting a preset feature from the historical data of the user, and training the user behavior decision module and the supervised model error correction module by using the preset feature as a training parameter.

Accordingly, as shown in FIG. 3, the method according to the embodiment specifically includes steps 310 to 350.

Step 310 includes: determining a target error correction level based on an error correction need of a user.

320: selecting at least one error correction module from each of at least two error correcting portions of the error correction platform based on the target error correction level.

330: acquiring historical data of the user from the error correction need of the user.

Here, the historical data of the user may be a behavior log of the user. Different users have different historical data. Incorrect behaviors and correct behaviors of the user may be fitted by collecting historical behavior data of the user. As an example, for a drug retrieval system of a hospital, doctor A inputs an incorrect drug name P first, and inputs a corrected correct drug name Q next time, and both the corrected drug name and the incorrected drug name may be used as the historical user data of the doctor A. As an example, if the doctor A inputs the drug name P for the drug name Q multiple times, then this behavioral habit may be exploited from the historical user data of the doctor A, and the incorrect segment inputted by the doctor A and the correct segment corresponded thereto may be determined. For example, the incorrect drug name P should correspond to the correct drug name Q. When the doctor A inputs the incorrect drug name P again, the inputted drug name P actually corresponding to the drug name Q may be determined based on his behavioral habit. Therefore, incorrect behaviors and correct behaviors corresponding thereto of the user may be fitted by statistics of historical behavior data of the user, and used as the basis for the error correction by the error correction platform, so that the error correction result is more consistent with the behavioral habit of the user, and the error correction rate is higher.

Furthermore, with the increase of the number of users, historical data of different users may be collected as the basis for subsequent training of the error correction model.

Step 340 includes: extracting a preset feature from the historical data of the user.

Here, the preset feature may include input habit information of the user, for example, for a certain drug Q, whether the user is likely to input a drug P for the drug Q, or whether a sequence inputted by the user is reasonable, such as whether “shenem” is inputted for the “shenme”.

As an example, a unique behavioral feature of each user may be extracted, or a common behavioral feature of multiple users may be acquired from statistics of the historical data of the user. For example, if a large number of users is likely to input an incorrect drug name P when they intend to input the drug name Q, then the behavioral habit of the large number of users may be used not only as the behavioral feature of the users, but also as candidate feature information of the drug retrieval system during error correction.

Step 350 includes: training the user behavior decision module and the supervised model error correction module by using the preset feature as a training parameter, to obtain an error correction model.

As an example, factors associated with the error correction are parameterized, and the user behavior decision module and the supervised model error correction module may be trained using the parameters to obtain the error correction model. The error correction model may be adjusted in time based on different training parameters.

As an example, the acquiring historical data of the user from the error correction need of the user, and training the error correction module using the historical data of the user may further include:

acquiring the historical data of the user from the error correction need of the user; acquiring an annotated corpus from the historical data of the user, and training the supervised model error correction module and the aligned segment recall module using the annotated corpus to obtain the error correction model.

Here, the annotated corpus refers to corresponding annotated information added to historical user data whose correct corpus and incorrect corpus inputted by the user are distinguished. The error correction model obtained through training the supervised model error correction module and the aligned segment recall module using the annotated corpus may effectively identify the corpus inputted by the user. When the user inputs an incorrect corpus, the best error correction result may be returned to the user.

This embodiment is optimized on the basis of the above embodiments, and the historical data of the user is acquired, and the behavior log or the annotated corpus of the user is acquired from the historical data of the user, which may be used as a part of very important data of the basis for adjusting the error correction model. An individualized error correction model meeting the error correction need of the user may be obtained through training the user behavior decision module and the supervised model error correction module by using the preset feature extracted from the behavior log of the user as the training parameter, or through training the supervised model error correction module and the aligned segment recall module using the annotated corpus. When a website develops to a mature stage and stores a large amount of user data, customizing the error correction model may be completed by extracting the feature associated with a behavioral habit of the user from the historical data of the user, and selecting a corresponding error correction module without redeveloping a new error correction model corresponding to a current development stage. The customized error correction model may adapt to website development and continuous user data accumulation, thereby effectively improving the accuracy rate and recall rate of the error correction model.

### Fourth Embodiment

FIG. 4 is a block diagram of a structure of an apparatus for establishing an error correction model based on an error correction platform according to a fourth embodiment of the disclosure. As shown in FIG. 4, the apparatus includes: an error correction level determining module 410 and an error correction model formation module 420.

The error correction level determining module 410 is configured to determine a target error correction level based on an error correction need of a user; and the error correction model formation module 420 is configured to select at least one error correction module from each of at least two error correcting portions of the error correction platform based on the target error correction level, and combine the selected error correction modules to form an error correction model.

The embodiment of the disclosure provides an apparatus for establishing an error correction model based on an error correction platform, and has solved the problems of existing technologies, such as a high coupling degree between the error correction model and a website, and failure to adapt to each development stage of the website by determining the target error correction level based on the error correction need of the user, and selecting at least one error correction module from each of at least two error correcting portions of the error correction platform based on the target error correction level, combining the selected error correction modules to form the error correction model. With above technical solution, as the website continuously develops and effective resources continuously increase, redeveloping a reusable platform-based error correction solution matching the current application scenario and the development stage is not needed, and quickly and easily customizing an error correction model corresponding to a specific application scenario and a current development stage of a website based on actual error correction need of the user are achieved.

On the basis of the above embodiments, the error correction model formation module 420 includes:

a customized scenario determining unit, configured to determine a customized scenario from the error correction need of the user; and

an error correction module selection unit, configured to select at least one error correction module from each of the at least two error correcting portions of the error correction platform based on the target error correction level and the customized scenario.

On the basis of the above embodiments, the apparatus further includes:

a training module, configured to, after the selecting at least one error correction module from each of at least two error correcting portions of the error correction platform based on the target error correction level, obtain historical data of the user from the error correction need of the user, and train the error correction module using the historical data of the user.

On the basis of the above embodiments, the at least two error correcting portions include: a normalizing portion, an error correction need intensity determining portion, a candidate recalling portion, or an error correction candidate rating and generating portion.

On the basis of the above embodiments, the error correction model formation module 420 is specifically configured to: select a normalization module from the normalizing portion of the error correction platform; select a policy white list module, a segment compactness entropy module and a user behavior decision module from the error correction need intensity determining portion; select a language model recall module, a double deletion method recall module and an aligned segment recall module from the candidate recalling portion; and select a basic static error correction module and a supervised model error correction module from the error correction candidate rating and generating portion.

On the basis of the above embodiments, the error correction model formation module 420 is specifically configured to:

acquire a user defined dictionary and a user defined rule from the error correction need of the user;

select the language model recall module from the candidate recalling portion of the error correction platform based on the target error correction level and the user defined dictionary; and

select the policy white list module from the error correction need intensity determining portion of the error correction platform based on the target error correction level and the user defined rule.

On the basis of the above embodiments, the training module is specifically configured to acquire the historical data of the user from the error correction need of the user;

extract a preset feature from the historical data of the user; and

train the user behavior decision module and the supervised model error correction module by using the preset feature as a training parameter.

On the basis of the above embodiments, the training module is specifically configured to acquire the historical data of the user from the error correction need of the user;

acquire an annotated corpus from the historical data of the user, and train the supervised model error correction module and the aligned segment recall module using the annotated corpus.

The apparatus for establishing an error correction model based on an error correction platform according to the embodiment of the disclosure may execute the method for establishing an error correction model based on an error correction platform according to any embodiment of the disclosure, and has corresponding function modules for executing the method and achieving beneficial effects.

### Fifth Embodiment

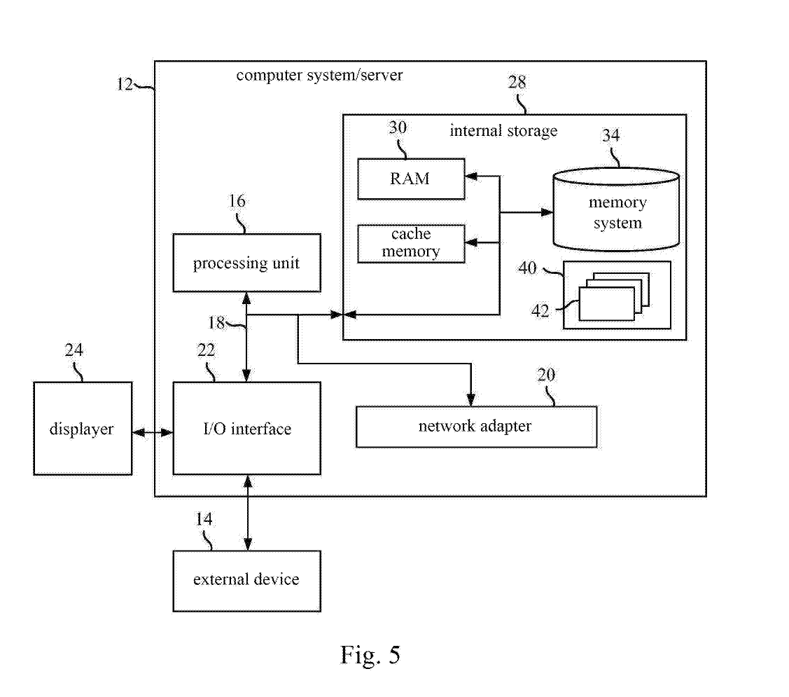

FIG. 5 is a schematic diagram of a structure of a device according to a fifth embodiment of the disclosure. FIG. 5 shows a block diagram of an illustrative device 12 that is suitable for implementing the embodiment of the disclosure. The device 12 shown in FIG. 5 is only an example, and should not limit the functions and scope of application of the embodiments of the disclosure in any way.

As shown in FIG. 5, the device 12 is expressed in the form of a general-purpose computing device. Components of the device 12 may include, but are not limited to: one or more processors or a processing unit 16, a system memory 28, and a bus 18 connecting different system components (including the system memory 28 and the processing unit 16).

The bus 18 represents one or more bus structures, including a memory bus or a memory controller, a peripheral bus, a graphics acceleration port, a processor, or a local bus of any one of the bus structures. For example, the system structures include, but are not limited to, an industrial standard architecture (ISA) bus, a micro channel architecture (MAC) bus, an enhanced ISA bus, a Video Electronics Standards Association (VESA) local bus, and a peripheral component interconnection (PCI) bus.

The device 12 typically includes multiple computer system readable media. These medias may be any available media that can be accessed by the device 12, including volatile media, non-volatile media, removable media and non-removable media.

The system memory 28 may include a computer system readable medium in the form of a volatile memory, such as a random access memory (RAM) 30 and/or a cache memory 32. The device 12 may further include other removable/non-removable, volatile/non-volatile computer system storage media. By way of example only, a storage system 34 may be used for reading from and writing in non-removable and nonvolatile magnetic media (not shown in FIG. 5, usually known as a “hard drive”). Although not shown in FIG. 5, a disk drive for reading from and writing in a removable non-volatile disk (such as a “floppy disk”) and an optical driver for reading from and writing in a removable non-volatile disk (such as CD-ROM, DVD-ROM or other optical media) may be provided. With such arrangements, each driver may be connected to the bus 18 through one or more data media interfaces. The memory 28 may include at least one program product, the program product has a set of (e.g., at least one) program module, and the program module is configured to execute the functions of the embodiments of the disclosure.

A program/utility tool 40 with a set of (at least one) program module 42 may be stored in, e.g., the memory 28. The program module 42 includes, but is not limited to, an operating system, one or more applications, other program modules, and program data. Each of these examples or a combination thereof may include implementation of a network environment. The program module 42 usually executes the functions and/or methods according to the embodiments of the disclosure.

The device 12 may also communicate with one or more external devices 14 (e.g., a keyboard, a pointing device, and a displayer 24), and may also communicate with one or more devices that enable a user to interact with the device 12, and/or communicates with any other device (e.g., a network card and a modem) that enables the device 12 to communicate with one or more of other computing devices. This communication may be performed through an input/output (I/O) interface 22. Moreover, the device 12 may further communicate with one or more networks (e.g., a local area network (LAN), a wide area network (WAN) and/or a public network such as the Internet) through a network adapter 20. As shown in the FIG. 5, the network adapter 20 communicates with other modules of the device 12 through the bus 18. It should be appreciated that, although not shown in the figure, other hardware and/or software modules may be used in conjunction with the device 12, including but not limited to: a microcode, a device driver, a redundancy processing unit, an external disk drive array, a RAID system, a tape driver, and a data backup storage system.

The processing unit 16 executes various functional applications and data processing by running a program stored in the system memory 28, such as implementing the method for establishing an error correction model based on an error correction platform according to an embodiment of the disclosure.

### Sixth Embodiment

A sixth Embodiment of the disclosure further provides a storage medium comprising a computer executable instruction, where the computer executable instruction, when executed by a computer processor, executes the method for establishing an error correction model based on an error correction platform according to any embodiment of the disclosure. The method for establishing an error correction model based on an error correction platform includes:

determining a target error correction level based on an error correction need of a user; and

selecting at least one error correction module from each of at least two error correcting portions of the error correction platform based on the target error correction level, and combining the selected error correction modules to form an error correction model.

The computer storage medium according to the embodiment of the disclosure may use any combination of one or more computer readable media. The computer readable medium may be a computer readable signal medium or a computer readable storage medium. The computer readable storage medium may, for example, be, but is not limited to, an electric, magnetic, optical, electromagnetic, IR or semiconductor system, device or unit, or any combination thereof. More specific examples (non-exhaustive list) of the computer readable storage medium include: an electrical connection having one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination thereof. Herein, the computer readable storage medium may be any tangible medium containing or storing programs, which may be used by an instruction execution system, device or unit, or a combination thereof.

The computer readable signal medium may be a data signal included in the baseband or transmitted as a part of carrier wave, and carries computer readable program codes. The data signal may be transmitted in multiple forms, including but not limited to an electromagnetic signal, an optical signal or any appropriate combination thereof. The computer readable signal medium may also be any computer readable medium rather than a computer readable storage medium, and the computer readable medium may send, spread or transmit programs to be used by an instruction execution system, device or unit, or a combination thereof.

Program codes contained in the computer readable medium may be transmitted using any suitable medium, including but not limited to: wireless, wire, cable, RF, etc., or any appropriate combination thereof.

A computer program code for executing the operations according to the disclosure may be written in one or more programming languages or a combination thereof. The programming language includes an object-oriented programming language, such as Java, Smalltalk and C++, and further includes a general procedural programming language, such as “C” language or a similar programming language. The program codes may be executed entirely on a computer of a user, executed partially on a computer of a user, executed as a standalone package, executed partially on the computer of the user and partially on a remote computer, or executed entirely on the remote computer or a server. When the remote computer is involved, the remote computer may be connected to a user computer through any type of network, including a local area network (LAN) or a wide area network (WAN), or be connected to an external computer (e.g., connected through Internet provided by an Internet service provider).

It is to be noted that the foregoing embodiments are merely preferred embodiments of the present disclosure, and the technical principles used thereby. Persons skilled in the art may understand that the present disclosure is not limited to the specific embodiments described herein. Persons skilled in the art may make various obvious changes, readjustments and substitutions without departing from the protection scope of the present disclosure. Therefore, although reference is made to the present disclosure in more detail in the foregoing embodiments, the present disclosure is not merely limited to the foregoing embodiments, more additional equivalent embodiments may be further included without departing from the conception of the present disclosure. The scope of the present disclosure is determined by the scope of the appended claim.

What is claimed is:

1. A method for establishing an error correction model based on an error correction platform, comprising:
determining a target error correction level based on an error correction need of a user; and
selecting at least one error correction module from each of at least two error correcting portions of the error correction platform based on the target error correction level, and combining the selected error correction modules to form an error correction model.

2. The method according to claim 1, wherein the selecting at least one error correction module from each of at least two error correcting portions of the error correction platform based on the target error correction level comprises:
determining a customized scenario from the error correction need of the user, and selecting at least one error correction module from each of the at least two error correcting portions of the error correction platform based on the target error correction level and the customized scenario.

3. The method according to claim 1, wherein after the selecting at least one error correction module from each of the at least two error correcting portions of the error correction platform based on the target error correction level, the method further comprises:
acquiring historical data of the user from the error correction need of the user, and training the error correction module using the historical data of the user.

4. The method according to claim 2, wherein the at least two error correcting portions comprise: a normalizing portion, an error correction need intensity determining portion, a candidate recalling portion, or an error correction candidate rating and generating portion.

5. The method according to claim 4, wherein the selecting at least one error correction module from each of at least two error correcting portions of the error correction platform comprises:
selecting a normalization module from the normalizing portion of the error correction platform;
selecting a policy white list module, a segment compactness entropy module and a user behavior decision module from the error correction need intensity determining portion;
selecting a language model recall module, a double deletion method recall module and an aligned segment recall module from the candidate recalling portion; and
selecting a basic static error correction module and a supervised model error correction module from the error correction candidate rating and generating portion.

6. The method according to claim 5, wherein the determining a customized scenario from the error correction need of the user, and selecting at least one error correction module from each of the at least two error correcting portions of the error correction platform based on the target error correction level and the customized scenario comprises:
acquiring a user defined dictionary and a user defined rule from the error correction need of the user;
selecting the language model recall module from the candidate recalling portion of the error correction platform based on the target error correction level and the user defined dictionary; and
selecting the policy white list module from the error correction need intensity determining portion of the error correction platform based on the target error correction level and the user defined rule.

7. The method according to claim 5, wherein the acquiring historical data of the user from the error correction need of the user, and training the error correction module using the historical data of the user comprises:
acquiring the historical data of the user from the error correction need of the user; and
extracting a preset feature from the historical data of the user; and
training the user behavior decision module and the supervised model error correction module by using the preset characteristic as a training parameter.

8. The method according to claim 5, wherein the acquiring historical data of the user from the error correction need of the user, and training the error correction module using the historical data of the user comprises:
acquiring the historical data of the user from the error correction need of the user; and
acquiring an annotated corpus from the historical data of the user, and training the supervised model error correction module and the aligned segment recall module using the annotated corpus.

9. An apparatus for establishing an error correction model based on an error correction platform, comprising:
at least one processor; and
a memory storing instructions, the instructions when executed by the at least one processor, cause the at least one processor to perform operations, the operations comprising:
determining a target error correction level based on an error correction need of a user; and
selecting at least one error correction module from each of at least two error correcting portions of the error correction platform based on the target error correction level, and combine the selected error correction modules to form an error correction model.

10. The apparatus according to claim 9, wherein the selecting at least one error correction module from each of at least two error correcting portions of the error correction platform based on the target error correction level comprises:
determining a customized scenario from the error correction need of the user, and selecting at least one error correction module from each of the at least two error correcting portions of the error correction platform based on the target error correction level and the customized scenario.

11. The apparatus according to claim 9, wherein after the selecting at least one error correction module from each of the at least two error correcting portions of the error correction platform based on the target error correction level, the operations further comprise:
acquiring historical data of the user from the error correction need of the user, and training the error correction module using the historical data of the user.

12. The apparatus according to claim 10, wherein the at least two error correcting portions comprise: a normalizing portion, an error correction need intensity determining portion, a candidate recalling portion, or an error correction candidate rating and generating portion.

13. The apparatus according to claim 12, wherein the selecting at least one error correction module from each of at least two error correcting portions of the error correction platform comprises:
selecting a normalization module from the normalizing portion of the error correction platform;
selecting a policy white list module, a segment compactness entropy module and a user behavior decision module from the error correction need intensity determining portion;
selecting a language model recall module, a double deletion method recall module and an aligned segment recall module from the candidate recalling portion; and
selecting a basic static error correction module and a supervised model error correction module from the error correction candidate rating and generating portion.

14. The apparatus according to claim 13, wherein the determining a customized scenario from the error correction need of the user, and selecting at least one error correction module from each of the at least two error correcting portions of the error correction platform based on the target error correction level and the customized scenario comprises:
acquiring a user defined dictionary and a user defined rule from the error correction need of the user;
selecting the language model recall module from the candidate recalling portion of the error correction platform based on the target error correction level and the user defined dictionary; and
selecting the policy white list module from the error correction need intensity determining portion of the error correction platform based on the target error correction level and the user defined rule.

15. The apparatus according to claim 13, wherein the acquiring historical data of the user from the error correction need of the user, and training the error correction module using the historical data of the user comprises:
acquiring the historical data of the user from the error correction need of the user; and
extracting a preset feature from the historical data of the user; and
training the user behavior decision module and the supervised model error correction module by using the preset characteristic as a training parameter.

16. The apparatus according to claim 13, wherein the acquiring historical data of the user from the error correction need of the user, and training the error correction module using the historical data of the user comprises:
acquiring the historical data of the user from the error correction need of the user; and
acquiring an annotated corpus from the historical data of the user, and training the supervised model error correction module and the aligned segment recall module using the annotated corpus.

17. A non-transitory computer medium comprising a computer executable instruction, wherein the computer executable instruction, when executed by a computer processor, causes the computer processor to perform operations, the operations comprising:
determining a target error correction level based on an error correction need of a user; and
selecting at least one error correction module from each of at least two error correcting portions of the error correction platform based on the target error correction level, and combine the selected error correction modules to form an error correction model.
